(19) United States
(12) Patent Application Publication
(10) Pub. No.: US 2010/0302436 A1
(43) Pub. Date: Dec. 2, 2010

(54) WEBCAM-TYPE CAMERA DESIGNED FOR MOUNTING ON A SCREEN

(75) Inventors: Bertrand Gasnier, Porcaro (FR); Olivier Martel, Bains Sur Oust (FR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: GUILLEMOT CORPORATION S.A., Chantepie (FR)

(21) Appl. No.: 12/786,790

(22) Filed: May 25, 2010

(30) Foreign Application Priority Data
May 29, 2009 (FR) 0953605

(51) Int. Cl. H04N 5/225

(52) U.S. Cl. 348/373; 348/E05.024

(57) ABSTRACT

The invention relates to a camera designed to be mounted on a screen, including an attachment segment (1) and a shooting segment (3), movable in relation to said attachment segment (1). According to the invention, the shooting segment (3) is movable in relation to the attachment segment so as to be able to take up, once the camera is mounted on a screen, at least two positions in relation to this screen (10): a conversation position in which said optical sensor (4) is placed over a portion of a display zone of said screen; a retracted position in which said optical sensor (4) is moved away from said display zone of said screen (10), so as to completely free up said display zone.

### FIELD OF THE INVENTION

The invention relates to a webcam-type camera designed for mounting on a screen and used, in particular, to carry out conversations in video mode on a public or private digital network.

### BACKGROUND

A wide variety of cameras exist which allow for carrying out conversations in video mode on a digital network. These cameras may be split up into two main groups: cameras integrated directly into a computer through which the video conversation will be carried out, and mobile cameras which may be connected to various types of computer hardware depending on requirements. Mobile cameras include, for example, USB-type connection means or equivalent which allow the camera to be connected to a computer, and means for attaching the camera to an edge of the computer's screen, for example in the form of a clip. The invention described herein relates to a mobile camera in the second group.

The U.S. Pat. No. 6,679,463 patent document describes an example of a camera in this second group, designed for mounting on a screen and including an attachment segment including means for attaching the camera to a screen, and a shooting segment, movable in relation to said attachment segment and including an optical sensor.

Such a camera allows for carrying out conversations in video mode in particular, better known in English as a “video chat”. To start up a video chat session, each user launches a software application on his or her computer, which initiates and maintains a connection between the two remote computers, via a digital network. Once this connection has been established, each user can view a window on his or her screen in which the user with whom he or she wishes to chat appears. The images of the user transmitted to the interlocutor are images acquired by the camera. The sound is acquired by a microphone which is either independent of the camera, or else integrated into the camera. This kind of video chat session lets you have a conversation with a remote user as though he or she were right in front of you.

In addition to computers, some television sets include a USB (Universal Serial Bus) port and may be connected to the Internet, the computer being connected via a wired connection to a modem or to a router or even to a PLC (Power Line Communication) adapter via the computer's Ethernet port, or via a wireless connection (by Wi-Fi, for example). It is therefore probable that in the near future, these television sets will be capable of recognizing and controlling the video and audio stream of a webcam connected to said USB port.

Moreover, some video game consoles used with a television set can recognize a webcam connected to one of their USB ports and may be connected to the Internet, the game console being connected via a wired connection to a modem or to a router or even to a PLC adapter via the console's Ethernet port.

One of the drawbacks currently encountered during a video chat session with a camera such as described in U.S. Pat. No. 6,679,463 lies in the fact that the user views the window in which the image of his or her interlocutor is displayed, and not the camera shooting him- or herself. Thus, the remote interlocutor does not have the sensation that the user is looking at him or her, as the user isn't looking at the camera. This gives the impression that the user is squinting or that he or she is not really concentrating on and focused on the conversation they are having. This drawback is encountered systematically with all cameras currently available on the market. In the pages which follow, we shall refer to this phenomenon as the squinting effect.

Another drawback of the camera described in U.S. Pat. No. 6,679,463 lies in the fact that when the camera is attached to the screen of a portable computer, the user is unable to close this computer. This is particularly annoying as the camera, along with the computer's screen and keyboard, are therefore exposed to dust.

Another drawback of the camera described in U.S. Pat. No. 6,679,463 lies in the fact that its attachment means prohibit a solid attachment to one of the screen's lateral edges.

### OBJECTIVES OF THE INVENTION

The invention aims to overcome at least some of the drawbacks of state of the art cameras.

In particular, the invention aims to produce, in at least one embodiment, a webcam-type camera which allows for the elimination of, or at least the reduction of, the squinting effect, which is to say the phenomenon whereby a user has the sensation that his or her interlocutor is not looking at him or her during a video chat session.

The invention also aims to produce, in at least one embodiment, a camera which can be attached equally well on the lateral edges of a screen, on the upper edge of a screen, or on the lower edge of a screen.

The invention also aims to produce, in at least one embodiment, a camera which can be attached to different types of screens of different thi

[symbol]

The invention also aims to produce, in at least one embodiment, a camera which does not prohibit the closing of a portable computer (including, but not limited to, a netbook) when the camera is attached to its screen.

The invention also aims to produce, in at least one embodiment, a camera which can allow for orientation of the optical sensor to face the user, wherever the camera may be mounted on the screen.

### SUMMARY OF THE INVENTION

To achieve this, the invention relates to a camera designed for mounting on a screen, including an attachment segment including means for attaching the camera to a screen, and a shooting segment, movable in relation to said attachment segment and including an optical sensor.

A camera according to the invention is characterized by the fact that said shooting segment is movable in relation to the attachment segment, allowing it to be put into, once the camera is mounted on a screen, at least two positions in relation to this screen:
one position, referred to as the conversation position, in which said optical sensor is placed over a portion of a display zone of said screen, so that said optical sensor may be placed in proximity to a display window displaying at least one image of an interlocutor, or over a portion of a display window in proximity to the interlocutor's face;
one position, referred to as the retracted position, in which said optical sensor is moved away from said display zone of said screen, so as to completely free up said display zone.

A camera according to the invention therefore allows, in the conversation position, for placement of the shooting segment in such a way that the optical sensor is placed over a portion of a display zone of the screen on which the camera is mounted and in proximity to the surface of this portion of the display zone (therefore the optical sensor is in front of the user of the camera, between the display zone of screen and the user). The position of the optical sensor in front of the screen, over a portion of the display zone, allows for the optical sensor to be immediately adjacent to the display window of the interlocutor with whom the user is communicating during a video chat session. This proximity between the display window and the optical sensor therefore allows for the elimination of the sensation that the user is not looking his or her interlocutor in the eyes during a video chat session. In effect, in this position, the user, by viewing his or her interlocutor in the display window, is captured practically in a direct full-face view by the optical sensor, the optical sensor being positioned in such a way that it is immediately adjacent to this display window. Similarly, the invention allows for positioning the optical sensor in proximity to the interlocutor's face—or even between the eyes, if the interlocutor is being shot very close up—when the display window is large, in particular if the video chat window is displayed in full screen mode. The squinting effect previously described is therefore limited by the use of a camera according to the invention.

The inventors have overcome a prejudice of persons having ordinary skill in the art, which consists of not wanting to cover a part of the screen's display zone with the camera. In particular, the inventors, by covering a part of the screen with the camera in the conversation position, have succeeded in eliminating the squinting effect which had heretofore been considered inherent to video chat sessions. Persons having ordinary skill in the art have been all the more inclined not to cover a portion of the display zone with the camera, so that the camera could be used with the screen of a netbook in particular, these types of screens being small in size: during video chat sessions, users wish, for example, to view the portion of the display zone which is used for notification of messages. Also, as nearly all netbooks are equipped with a built-in camera, there was no incentive to add a removable camera, which moreover hides a part of the display zone during video chat sessions.

In addition, resolving the squinting effect by positioning the camera in front of the screen was a priori incompatible with the objective of not preventing a portable computer from being closed when this camera is attached to its screen.

Moreover, the shooting segment of a camera according to the invention may be moved to a retracted position in which the optical sensor is away from the screen's display zone so as to completely free up the display zone.

The optical sensor of a camera according to the invention may therefore occupy a position in which it is located outside of the display zone. This position, which corresponds to the retracted position, is the position in which most prior art cameras are positioned.

The shooting segment of a camera according to the invention may also occupy a position in which the optical sensor is located in front of the screen, which is to say it is located between the screen and the user, with its back to the screen to be able to film the user, who is facing the screen, so that he or she may view his or her interlocutor in a display window.

Advantageously and according to at least one embodiment of the invention, the shooting segment is movable in rotation in relation to a first axis of rotation.

Advantageously and according to at least one embodiment of the invention, the shooting segment is movable in translation in relation to the attachment segment.

Advantageously and according to at least one embodiment of the invention, in said retracted position, said shooting segment is rotated by 90° in relation to said conversation position.

According to this embodiment, moving from the conversation position to the retracted position is the result of a movement of a quarter turn of the shooting segment around the first axis of rotation. It is therefore particularly practical, with a camera according to this embodiment, to move from a conversation position to a retracted position, with a single movement. A user may therefore move the camera with one hand while using a mouse with the other hand in order to initiate or end a video chat session, for example.

Advantageously, a camera according to the invention includes two stops and/or two notches corresponding to the conversation position and to the retracted position, respectively.

The presence of stops and/or notches allows for facilitating the positioning of the shooting segment in each of the conversation and retracted positions.

According to the invention, the shooting segment includes an optical sensor adapted to ensure shots of a user. According to one embodiment, the distance between the center of the optical sensor and the first axis of rotation around which the shooting segment can pivot to move from the conversation to the retracted position, is fixed or movable.

Advantageously and according to one embodiment of the invention, the distance between the first axis of rotation and the center of said optical sensor is greater than or equal to 4 cm.

This minimum distance of 4 cm guarantees, for the majority of screen models available on the market, that the optical sensor, once in the conversation position, is over a portion of the screen's display and, above all, that this distance also allows the optical sensor to be positioned closer to the interlocutor's image displayed and to his or her eyes. In particular, the majority of screens generally feature a plastic or metallic border which encircles the screen and on which a camera according to the invention will be mounted. This border is generally less than 2 or 3 cm in width or in height, and the image of the eyes displayed in the display portion is located a minimum of 1 cm from this border. Therefore, a distance of 4 cm between the first axis of rotation and the optical sensor allows the optical sensor to be placed in the conversation position beyond the border of the screen.

As a variation or in combination, the optical sensor is movable in relation to the first axis of rotation.

Advantageously and according to one embodiment of the invention, the shooting segment includes at least two pieces mounted in a telescopic manner, so as to be able to modify the distance between the first axis of rotation and the center of the optical sensor.

According to this variation, the movable optical sensor can be moved in relation to the first axis of rotation to be placed in such a way that it covers a display zone of the screen distant from the first axis of rotation. This allows for example, depending on the size of the screen and of the telescopic extension, for moving the optical sensor to the center of the screen, and/or for adapting the sensor's position to the position of the display window which displays the interlocutor on the screen and/or for positioning the optical sensor closer to the image of the interlocutor's eyes displayed on the screen.

Advantageously, a camera according to the invention includes an intermediate segment mounted between said attachment segment and said shooting segment, said intermediate segment being movable in rotation in relation to said attachment segment, around said first axis of rotation.

The intermediate segment makes it possible to increase the distance between the first axis of rotation and the optical sensor.

Moreover, advantageously and according to this variation, the shooting segment is movable in rotation in relation to said intermediate segment, around a second axis of rotation perpendicular to said first axis of rotation.

This additional feature allows for the optical sensor to be oriented in all directions, no matter where the camera is attached to the screen's border (i.e. no matter the screen's edge where the camera is attached).

The amplitude of the rotation of the shooting segment in relation to the intermediate segment around the second axis of rotation may be total or partial. For example, according to one embodiment, the shooting segment can pivot 360° around the second axis of rotation. Preferably, this rotation will feature predetermined hard spots allowing for the camera to be precisely positioned at certain predetermined angles.

Advantageously, a camera according to the invention includes two stops defining two extreme positions of rotation around said second axis of rotation, respectively at roughly −45° and 45° in relation to a central position of said shooting segment.

Advantageously and according to one embodiment of the invention, the intermediate segment includes at least one opening, inside of which runs at least one electrical cable connected to said optical sensor.

Advantageously, in this case, the intermediate segment includes two openings communicating with said attachment segment and said shooting segment, respectively.

These openings allow for running electrical cables powering the shooting system and for sending acquired data to a computer (or a game console or a television set).

Advantageously and according to the invention, these openings extend along the first and second axis of rotation, respectively.

This allows for elimination of the risks of deterioration of the electric cables during the rotations around the first and second axes of rotation.

Advantageously and according to one embodiment of the invention, the first axis of rotation is shifted in relation to the symmetry plane of said shooting segment.

Shifting the axis makes it possible to improve the camera's aesthetics when the camera is in its retracted position, in particular.

Moreover, a camera according to the invention advantageously includes an attachment segment including attachment means for attaching the camera to a screen.

These attachment means may be of any type: for example, they may include elastic clips which clip onto the screen. They may also include repositionable adhesive means which allow the camera to be attached to an edge of the screen, and to be moved when necessary. They may also include suction cup systems.

Advantageously and according to one embodiment of the invention, the camera may include attachment means for attaching the camera to an edge of the screen, even though for persons having ordinary skill in the art, attaching the camera to an edge of the screen was a priori incompatible with the objective of not preventing the closing of a portable computer's screen when the camera is attached to this screen.

The attachment means, combined with the movable nature of the shooting segment in relation to the attachment segment, the shooting segment being able to be placed in said conversation position and said retracted position, make it possible that when the camera is attached to the screen of a portable computer, the screen-cover of this computer can be closed without having to remove the camera. The camera can therefore remain attached to this computer when it is closed (the shooting segment must be in the retracted position). When closed in this way, this screen, along with the keyboard and the camera's optical sensor, are protected from dust (the shooting segment then being oriented towards the element supporting the portable computer—a desk or table, for example—and in proximity to the horizontal surface of said element). It is therefore possible to interrupt a video chat session and close the computer easily and quickly without having to detach the camera. In effect, starting with a camera in the conversation position, the camera can be moved into its retracted position with a single motion and the portable computer's screen-cover pulled down to close it. When the user reopens the portable computer's screen-cover, the optical sensor faces the user once again (the shooting segment is in the retracted position, and can be moved into the conversation position with a single motion). It is therefore quick and easy to return to a video chat session after an interruption.

Advantageously and according to one embodiment of the invention, the attachment means include a fixed jaw and a movable jaw.

Advantageously and according to this embodiment, the movable jaw is attached to an endless screw mounted in the attachment segment.

Attachment means incorporating fixed and movable jaws allow for the camera to be mounted on any edge of the screen, in particular on a lateral edge or the upper edge of the screen. Moreover, this type of mounting is quick and requires no tools, and can be carried out by any user. Finally, this type of mounting enables precise, solid and stable maintaining of a position over time, while also making it quick and easy to remove the camera.

Advantageously and according to one embodiment of the invention, the attachment segment and the shooting segment are formed so as to allow for the camera to be maintained in a stable position when attached to a flat surface.

Advantageously and according to one embodiment, the attachment segment is formed so as to allow for the camera to be maintained in a stable position when placed on a flat horizontal surface.

A camera according to this embodiment therefore allows it to be used not only mounted on a screen, but also as an auxiliary desktop camera.

Advantageously and according to one embodiment of the invention, the optical sensor is movable in rotation in relation to the shooting segment.

The invention also relates to a camera characterized in combination by all or some of the aforementioned features, or those mentioned hereinafter.

### BRIEF DESCRIPTION OF THE DRAWINGS

Other goals, features and advantages of the invention will be revealed upon reading of the following description, provided by way of illustration only and non-restrictive in nature, and which refers to the appended figures, in which:

FIG. 1 is a frontal schematic view of a camera according to an embodiment of the invention, mounted on a screen and placed in the conversation position.

FIG. 2 is a frontal schematic view of a camera according to an embodiment of the invention, mounted on a screen and placed in the retracted position.

FIG. 3 is a perspective schematic view of a camera according to an embodiment of the invention, including an attachment segment, an intermediate segment and a shooting segment.

FIG. 4 is a perspective schematic view of the camera according to the embodiment shown in FIG. 3, the shooting segment having been pivoted around the second axis of rotation.

FIG. 5 is a perspective schematic view of a camera according to an embodiment of the invention, in which the upper portions of the attachment and intermediate segments are not shown, in order to display the internal elements.

FIG. 6 is a perspective schematic view of a portion of the shooting and intermediate segments of a camera according to an embodiment of the invention.

FIG. 7 is a schematic view of a portion of the attachment segment and of a part of the intermediate segment, forming a first axis of rotation of a camera according to an embodiment of the invention.

FIG. 8 is a schematic view of a portion of the intermediate segment of a camera according to an embodiment of the invention.

FIG. 9 is a schematic view of a connecting element between the intermediate segment and the shooting segment of a camera according to an embodiment of the invention.

FIG. 10 is a schematic view of a portion of the intermediate segment and of a part of the shooting segment of a camera according to an embodiment of the invention, forming a second axis of rotation of a camera according to an embodiment of the invention.

### DETAILED DESCRIPTION

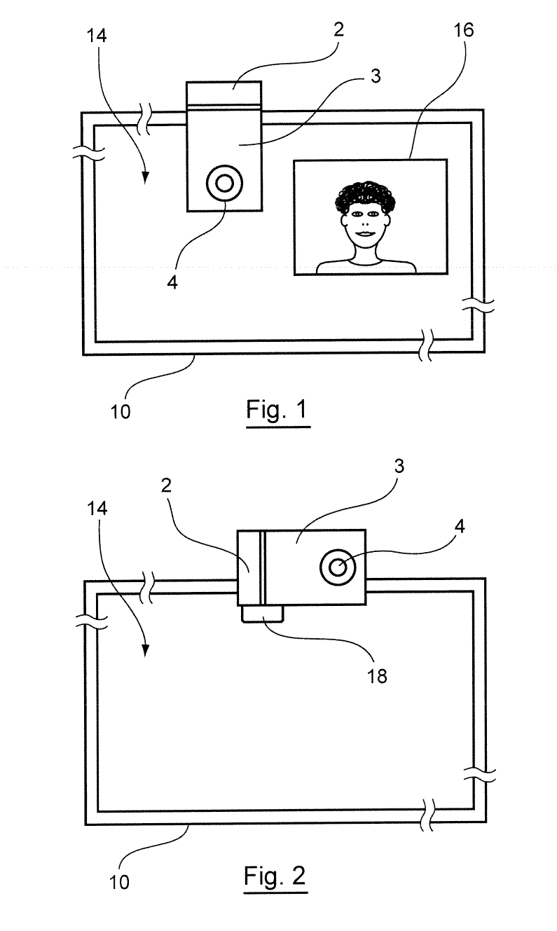

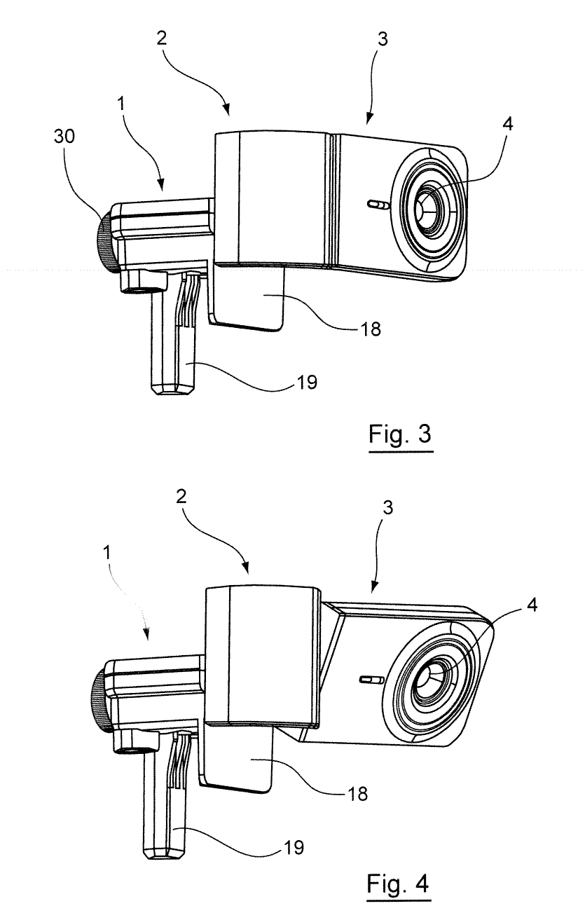

In the figures, the scales and proportions are not strictly respected, for the purposes of illustration and of clarity. In particular, the screen in FIGS. 1 and 2 is of a reduced scale in relation to that of the camera.

In all of the detailed description which follows in reference to the figures, without indication to the contrary, each piece of the camera is described as it is laid out when the camera is mounted on the upper edge of a screen and extending vertically, the different segments being aligned following one another. This layout is represented in FIG. 1, in particular.

A camera according to the invention includes an attachment segment 1 including attachment means for attaching the camera to a screen 10 (said screen may be, for example, a television screen or a desktop computer screen, but also a screen on portable devices for mobile use, such as a laptop computer, netbook, tablet PC, etc.), and a shooting segment 3, movable in relation to the attachment segment 1. According to a preferential embodiment, the camera also includes an intermediate segment 2, positioned between the attachment segment 1 and the shooting segment 3.

According to the embodiment of the figures, the intermediate segment 2 may be moved in rotation around a first axis 11 of rotation, in relation to the attachment segment 1. The shooting segment 3 can be moved in rotation around a second axis 12 of rotation, thanks to the intermediate segment 2. Also, the shooting segment 3 is movable in rotation in relation to the first axis 11 of rotation, in relation to the intermediate segment 2. Preferably, the first axis 11 of rotation is perpendicular to the second axis 12 of rotation.

The articulation between the different segments of a camera according to the invention is designed in such a way that the camera, once mounted on a screen 10, and as depicted in FIGS. 1 and 2, may be placed in at least two positions: a conversation position and a retracted position.

FIG. 1 depicts the camera in the conversation position. In this position, the shooting segment extends vertically in front of a portion of a display zone 14 of the screen 10 on which the camera is mounted. The optical sensor 4 is placed over a portion of the display zone 14 of the screen 10 on which the camera is mounted, in such a way that the optical sensor 4 may be placed in proximity to a display window 16 with at least one image of an interlocutor during the course of a video chat session. In this position, a user, by viewing his or her interlocutor in the display window 16, is captured practically in a direct full-face view by the optical sensor 4, the optical sensor being positioned in such a way that it is immediately adjacent to this display window 16. The camera according to the invention therefore allows for the elimination of the squinting effect previously described.

FIG. 2 depicts the camera in the retracted position. In this position, the optical sensor 4 is moved away from the display zone 14 of the screen 10, so as to completely free up the display zone 14.

Each of these segments—attachment, intermediate and shooting—may for example be made by a case 31, 32, 33 of plastic material formed by two shells attached to one another by bonding, by interlocking or by all equivalent methods.

The attachment segment 1 includes a case 31 and attachment means for attaching the camera to a screen 10. These attachment means include a fixed jaw 18 and a movable jaw 19, which can be moved in relation to the case 31 of the attachment segment.

The fixed 18 and movable 19 jaws are parallel to one another, so as to be able to clamp onto an edge of the screen 10 when they are moved close to each other. Preferably, the faces facing each other are covered with a non-abrasive and adherent material, rubber for example, so as to facilitate them fastening onto the edge of the screen, without scratching the edge of the screen 10.

The movable jaw 19 is moved in displacement towards the fixed jaw 18 by way of an endless screw 20. This endless screw 20 is extended axially by a wheel 30 which can be operated by a user, during the process of mounting the camera on the screen 10.

The movable jaw 19 features an upper portion lodged in the case 31 of the attachment segment 1, in gear with the endless screw 20 so as to be able to be moved by the endless screw; a lower part featuring a rounded and flat face designed to press up against the back part of the screen 10; and an intermediate part connecting the upper and lower parts. The case 31 of the attachment segment 1 includes an opening in the lower wall of the case 31 to allow for passage of the intermediate part of the movable jaw 19. The lower part of the movable jaw 19 includes a rounded portion. In effect, some screens do not have an edge which is truly at a right angle, but rather have a “streamlined” edge, generally so as to give an impression of thinness. This streamlined edge fits with the curve of the surface of the movable jaw 19. Without this curve, the camera would have a tendency to tilt when it is tightened, as the flat surface would tend to want to follow the curve of the streamlined edge. In the case of screens whose edges are at a truly right angle, as the lower part of the movable jaw 19 is covered with a soft rubber material, the rounded part is flattened to provide contact along all of the surface of the piece 19.

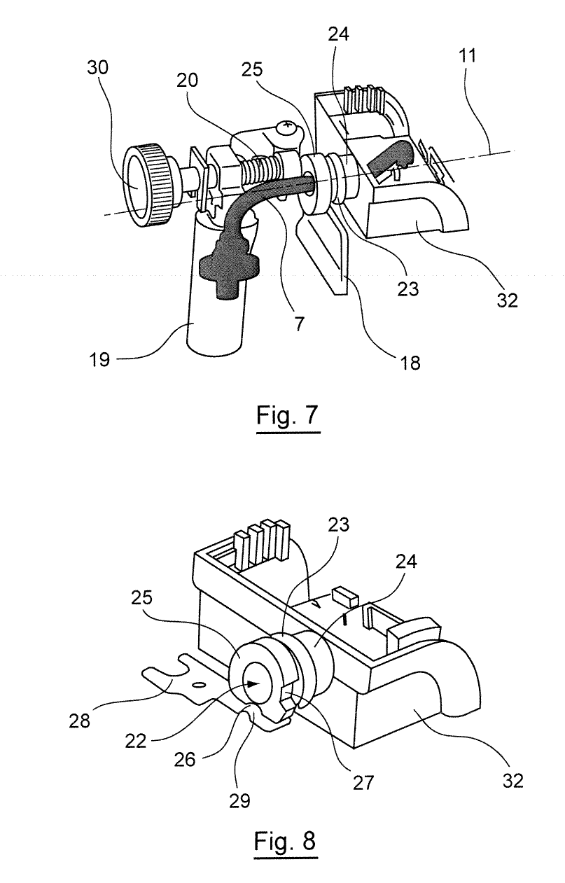

The intermediate segment 2 includes a case 32. FIG. 8 is a partial view of the case 32. FIG. 7 is a view of the connection zone between the attachment segment 1 and the intermediate segment 2 forming the first axis 11 of rotation.

The case 32 includes a shaft 24 forming a projection in relation to a lateral wall of the case 32 placed side-by-side with the case 31 of the attachment segment 1. This shaft 24 is borne by a platform formed by a lateral wall of the case 31 of the attachment segment 1.

This shaft 24 is also extended by a flange 25 which features two notches 26, 27 defining the positions of the end of rotation of the intermediate segment 2 in relation to the attachment segment 1. These notches 26, 27 therefore define the conversation position and the retracted position, respectively. According to the embodiment of the figures, these notches are separated by an angle of 90° in such a way that, in the retracted position, the shooting segment, connected to the intermediate segment, is rotated by 90° in relation to the conversation position. The locking of the position is carried out by a flexible metallic strip 28 connected to the case 31 of the attachment segment. This strip 28 features a lug 29 which is adapted to the notches 26, 27 in such a way that the rotation of the intermediate segment 2 is spontaneously constrained when the lug 29 is lodged in a notch 26, 27.

The shaft 24 also includes an elastic washer 23 designed to absorb the movement in rotation.

Moreover, this shaft 24 includes a traversing axial aperture which opens up on one side into the case 31 of the attachment segment 1 and into the intermediate case 2 to allow for the passage of at least one electrical cable 7. This electrical cable 7 allows for example for powering the optical sensor 4 of the shooting segment 3 and for sending the images acquired by the optical sensor 4 to a computer (or a game console or a television set) to which the camera is connected.

Finally, the case 32 of the intermediate segment includes an opening in its lower wall to allow for the passage of the electrical cable 7 to the case 33 of the shooting segment 3.

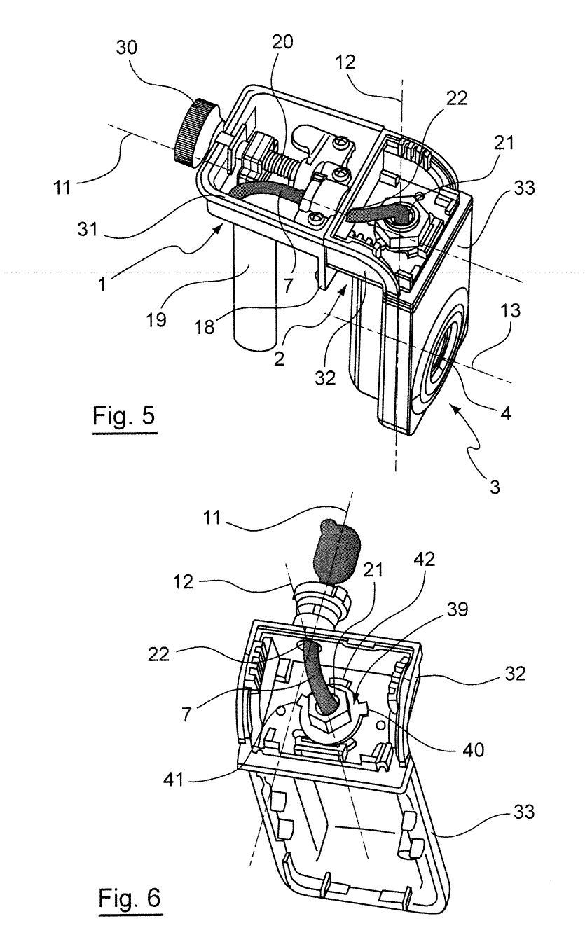

FIG. 5 is a view of a camera according to an embodiment of the invention in which the case 31 of the attachment segment and the case 32 of the intermediate segment 2 are partially opened in order to illustrate the mechanisms located inside of these cases 31, 32.

The shooting segment 3 includes a case 33. This case 33 houses the optical sensor 4 for shooting. FIG. 6 is a partial view of the case 33 and depicts the connection zone between the intermediate segment 2 and the shooting segment 3 forming the second axis 12 of rotation.

The case 33 features an opening coaxial to the opening made in the lower wall of the case 32 of the intermediate segment 2. These openings are not visible in the figures, as a threaded rod 35 is mounted in these openings.

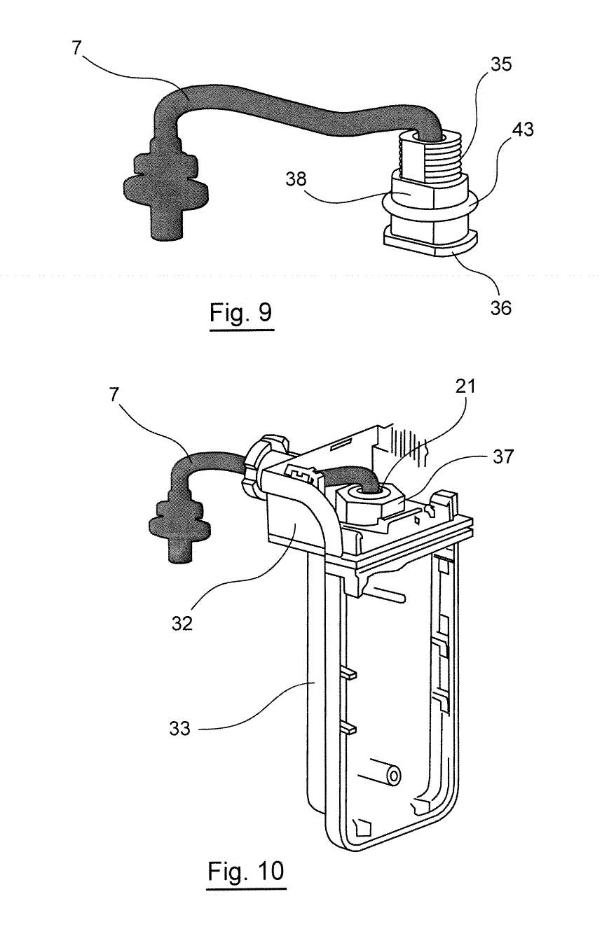

The hollow threaded rod 35 is shown in FIG. 9 in particular and allows for passage of the electrical cable 7.

The hollow threaded rod 35 includes a shoulder 36 which comes into contact against the peripheral contour of the opening in the upper wall of the case 33 of the shooting segment. Moreover, this threaded rod 35 includes two parallel flats 38 situated on either side of the rod's axis in such a way that once mounted in the openings of the cases, the rod does not pivot inside of the openings and remains fixed in relation to the cases 32, 33 of the intermediate 2 and shooting 3 segments. As illustrated in FIG. 10, a nut 37 positioned on the threaded rod 35 on the other side of the walls allows for blocking of the rod's axial movement. A washer 39 is also positioned around the rod, under the nut.

This washer 39 is visible in FIG. 6, in which the nut has not been depicted in order to illustrate the washer 39. This washer 39 features two stops 40, 41 separated from one another by an angle of 120°. According to other embodiments, the stops may be separated by an angle of 90° or otherwise. The lower wall of the case 32 of the intermediate segment also includes plastic stops designed to block the rotation of the shooting segment in relation to the intermediate segment when the stops 40, 41 come into contact with these stops. A stop 42 is positioned between the two stops 40, 41 and defines an alignment of the intermediate and shooting segments. In the embodiment whereby the stops are separated from one another by an angle of 120°, when the stop 40 encounters the stop 42, the shooting segment has made a rotation of 60°. When the stop 41 encounters the stop 42, the shooting segment has made a rotation of −60°. In the embodiment whereby the stops are separated from one another by an angle of 90°, when the stop 40 encounters the stop 42, the shooting segment has made a rotation of 45°. When the stop 41 encounters the stop 42, the shooting segment has made a rotation of −45°. The stops 40, 41 and the stop 42 therefore allow for limiting the rotation of the shooting segment 3 in relation to the intermediate segment 2.

Finally, the threaded rod includes an elastic washer 43 designed to absorb the looseness of the rotation.

According to an embodiment of the figures, the first axis 11 of rotation is shifted in relation to the symmetry plane of the shooting segment 3. Moreover, the symmetry plane of the shooting segment 3 coincides with the second axis 12 of rotation. The two axes of rotation are therefore not secant. According to another embodiment, these axes may be secant.

The shooting segment 3 also includes the optical sensor 4 which is not described in detail herein. Persons having ordinary skill in the art can easily integrate any kind of CCD or CMOS sensor or any equivalent sensor in the case 33 of the shooting segment to create a camera which conforms to the invention.

The distance between the first axis 11 of rotation and the center of the optical sensor 4 may be selected depending on the applications. According to an embodiment of the invention, this distance between the first axis of rotation and the center of the optical sensor is greater than or equal to 4 cm.

The cases are, according to the embodiment of the figures, roughly plane-parallel, so as to allow for the camera to be maintained in a stable position when placed on a flat surface.

The lower part of the attachment segment therefore includes a flat surface designed to come into contact with the roughly flat edge of the screen 10 and ensure that the camera is properly maintained in the retracted position. The roughly plane-parallel shape of the case 31, perpendicular to the fixed jaw 18, allows for the camera to be maintained in a stable position when placed on a flat surface; and the shooting segment 3 which can be moved in rotation around the second axis 12 of rotation in relation to the intermediate segment 2 allows for orientation of the shooting segment 3 in the desired direction (for example, if the camera is placed on a table, rotation around the second axis 12 allows for orientation of the optical sensor 4 upwards so as to capture not the table and the torso of the person being filmed, but rather the person's face). Such a camera can therefore also be used as a desktop camera.

Moving from the conversation position to the retracted position does not prohibit the optical sensor from filming. The camera can continue filming even in the retracted position, for example in order to film a scene independent of a conversation so that it can be sent later on by email or to put it online on the Internet. According to a particular embodiment, the optical sensor is movable in rotation in relation to the shooting segment so as to compensate for the rotation of the shooting segment, so that the image filmed by the camera remains in the correct orientation in relation to the horizon line (the video chat session can therefore continue even when the shooting segment is moved from the conversation position to the retracted position, without the image of the person being filmed by the camera becoming perpendicular in relation to the horizon line, for example).

By way of an example of mounting the optical sensor, the optical sensor can be mounted on a ring that is movable in rotation in relation to the case 33 and two stops defining two extreme positions of rotation around the axis of rotation of the optical sensor around an axis 13 of rotation, respectively at roughly 0° (for the conversation position) and at −90° (for the retracted position) in relation to a position of said shooting segment. Thus, the user can manually pivot the optical sensor by a quarter turn in the opposite direction of the rotation of the shooting segment in relation to the attachment segment. It may also be envisaged by way of a variation to mount the optical sensor on a stepper motor which moves it in rotation in relation to the case 33.

According to another variation of mounting the optical sensor, in order that the optical sensor remains in the same position in relation to the horizon line, the optical sensor is mounted on a gyroscopic device movable in rotation in relation to the case 33. Thus, the force of gravity allows for automatically pivoting the sensor by a quarter turn when the user moves the shooting segment from the conversation position to the retracted position.

According to a variation of the invention, a device which disables the gyroscopic device is incorporated, in such a way that the format of the image filmed by the camera does not always remain in the same shooting format selected by the camera's manufacturer (that is to say either the shooting format referred to as landscape format, or the shooting format referred to as portrait format).

According to another variation, a system of gears and pulleys relaying the movement of the shooting segment so as to drive the movement of the optical sensor in order to compensate for the effect of the rotation of the shooting segment is implemented.

According to another variation, the optical sensor is mounted on a rocker system by applying the same mechanism as that used in seesaws for children (such a seesaw is composed of 2 seats facing one another and attached to a pair of vertical posts, which are themselves connected at their upper ends to the top of the seesaw's support, but to either side of this support; the rocking movement, associated with the distance between the two vertical poles, allows the two seats to remain horizontal, within the limit of rotation around the fastening on the support). This type of mechanism is implemented in a camera by integrating the mechanism of two parallel posts inside of the shooting segment, and where the two seats are replaced by the optical sensor.

The invention is not limited to the embodiments described herein alone.

In particular, it is possible to envisage—according to an embodiment not represented in the figures—a shooting segment which is formed of at least two pieces mounted in a telescopic manner, so as to allow for modification of the distance between the first axis of rotation and the center of the optical sensor. Persons having ordinary skill in the art will encounter no difficulties in modifying the camera's shooting case 33 described with a telescopic case. Clearly, an electrical cable of sufficient length must be employed so as to allow for deployment of the telescopic case.

What is claimed is:

1. Camera designed for mounting on a screen (10) including an attachment segment (1) including removable attachment means for attaching the camera to an edge of the screen (10), and a shooting segment (3), movable in relation to said attachment segment (1) and including an optical sensor (4), wherein said shooting segment (3) is movable in relation to the attachment segment so as to be able to take up, once the camera is mounted on the edge of said screen (10), at least two positions in relation to this screen (10):
one position, referred to as the conversation position, in which said optical sensor (4) is placed over a portion of a display zone (14) of said screen (10),
one position, referred to as the retracted position, in which said optical sensor (4) is moved away from said display zone (14) of said screen (10), so as to completely free up said display zone (14).

2. Camera according to claim 1, wherein said shooting segment (3) is movable in rotation at least in relation to a first axis (11) of rotation.

3. Camera according to claim 1, wherein when in said retracted position, said shooting segment (3) is rotated by 90° in relation to said conversation position.

4. Camera according to claim 2, wherein the distance between the first axis (11) of rotation and the center of said optical sensor (4) is greater than or equal to 4 cm.

5. Camera according to claim 1, wherein the camera includes two stops and/or two notches (26, 27) corresponding to said conversation position and to said retracted position, respectively.

6. Camera according to claim 2, wherein the first axis (11) of rotation is shifted in relation to the symmetry plane of said shooting segment (3).

7. Camera according to claim 2, wherein the camera includes an intermediate segment (2) mounted between said attachment segment (1) and said shooting segment (3), said intermediate segment (2) being movable in relation to said attachment segment (1), around said first axis (11) of rotation.

8. Camera according to claim 7, wherein said shooting segment (3) is movable in rotation in relation to said intermediate segment (2), around a second axis (12) of rotation perpendicular to said first axis (11) of rotation.

9. Camera according to claim 8, wherein the camera includes two stops (40, 41), defining two extreme positions of rotation around said second axis (12) of rotation, at roughly −45° and 45° in relation to a central position of said shooting segment (3), respectively.

10. Camera according to claim 7, wherein said intermediate segment (2) includes at least one opening (21; 22) inside of which runs at least one electrical cable (7) connected to said optical sensor (4).

11. Camera according to claim 10, wherein said intermediate segment (2) includes two openings (21, 22) communicating with said shooting segment (3) and said attachment segment (1), respectively.

12. Camera according to claim 8, wherein said openings (21, 22) extend along the first and second axis of rotation, respectively.

13. Camera according to claims 1, wherein said attachment segment (3) includes a fixed jaw (18) and a movable jaw (19).

14. Camera according to claim 13, wherein said movable jaw is attached to an endless screw (20) mounted in said attachment segment (1).

15. Camera according to claim 1, wherein said attachment segment (1) and said shooting segment (3) are formed so as to allow for the camera to be maintained in a stable position on a flat surface, in said retracted position.

16. Camera according to claim 2, wherein said shooting segment (3) includes at least two pieces mounted in a telescopic manner, so as to modify the distance between said first axis (11) of rotation and the center of said optical sensor (4).

17. Camera according to claim 1, wherein said shooting segment (3) is movable in translation in relation to the attachment segment (1).

18. Camera according to claim 1, wherein said optical sensor (4) is mobile in rotation in relation to the shooting segment (3).
